(19) United States
(12) Patent Application Publication
(10) Pub. No.: US 2014/0108755 A1
(43) Pub. Date: Apr. 17, 2014

(54) MOBILE DATA LOSS PREVENTION SYSTEM AND METHOD USING FILE SYSTEM VIRTUALIZATION

(71) Applicant: Somansa Co., Ltd., Seoul (KR)

(72) Inventors: Seung Tae LUE, Seoul (KR); Seung Tae PAEK, Seoul (KR); Il Hoon CHOI, Seoul (KR)

(73) Assignee: Somansa Co., Ltd., Seoul (KR)

(21) Appl. No.: 14/051,000

(22) Filed: Oct. 10, 2013

(30) Foreign Application Priority Data
Oct. 12, 2012 (KR) 10-2012-0113638

(51) Int. Cl. G06F 3/06; G06F 12/14

(52) U.S. Cl. CPC G06F 3/0619; G06F 3/065; G06F 12/1408; G06F 3/067
USPC 711/162; 711/164

(57) ABSTRACT

Disclosed are a mobile DLP system and method. The mobile DLP system includes a general storage that allows an access in a normal mode and a security mode, an encrypted virtual storage that disallows an access in the normal mode and allows an access in the security mode, a management program that designates the general storage as a write/read area in the normal mode and designates the general storage and the virtual storage as the write/read area in the security mode, a fuse that intercepts a file input/output of an application program including the management program to again set a file input/output path as the virtual storage according to a command of the management program in the security mode, and a VFS engine that performs a bridge function between the application program of an application layer and the fuse of a kernel layer.

### CROSS-REFERENCE TO RELATED APPLICATIONS

This application claims priority under 35 U.S.C. §119 to Korean Patent Application No. 10-2012-0113638, filed on Oct. 12, 2012, the disclosure of which is incorporated herein by reference in its entirety.

### TECHNICAL FIELD

The present invention relates to data loss prevention (DLP), and more particularly, to a mobile DLP system and method using file system virtualization, which prevents the loss of data in a mobile environment.

### BACKGROUND

Recently, cases that use smartphones for work are increasing in large companies, security companies, insurance companies, etc. At present, smart office and smart work are being done, and thus, a smartphone user accesses a company network to view company information anywhere at any time.

Such smart office and smart work increase an efficiency of work, but when a worker accesses a company network with a smartphone, the risk of leaking company information increases.

Further, most of company information is important information, and there is a high possibility that the company information is core information. For this reason, it is urgently required to apply a DLP measure to a mobile environment which is used for work.

In addition, the government is recently controlling the protection and management of personal information with the information communication network act and the personal information protection act, and thus, a measure against data loss is needed for an open space in addition to a closed space such as a company.

### SUMMARY

Accordingly, the present invention provides a mobile DLP system and method using file system virtualization, which is used in a security mode by virtualizing a physical disk area.

The object of the present invention is not limited to the aforesaid, but other objects not described herein will be clearly understood by those skilled in the art from descriptions below.

In one general aspect, a mobile DLP system includes: a general storage configured to allow an access in a normal mode and a security mode; an encrypted virtual storage configured to disallow an access in the normal mode, and allow an access in the security mode; a management program configured to designate the general storage as a write or read area in the normal mode, and designate the general storage and the virtual storage as the write or read area in the security mode; a fuse configured to intercept a file input or output of an application program including the management program to again set a file input or output path as the virtual storage according to a command of the management program, in the security mode; and a VFS engine configured to perform a bridge function between the application program of an application layer and the fuse of a kernel layer.

In another general aspect, a file copy method of a mobile DLP system, including a general storage configured to allow an access in a normal mode and a security mode and an encrypted virtual storage configured to disallow an access in the normal mode and allow an access in the security mode, includes: when copy work is requested for copy from the virtual storage to the general storage, requesting, by an application program including a management program, authentication from a user requesting the copy work in the security mode; when the user is authenticated, analyzing a copy target file corresponding to the copy work, and transmitting the analyzed contents to request approval of the copy work; and when a notification indicating approval of an officer for the copy work is received from a server, copying the copy target file of the virtual storage to the general storage.

Other features and aspects will be apparent from the following detailed description, the drawings, and the claims.

### BRIEF DESCRIPTION OF THE DRAWINGS

FIG. 1 is a block diagram illustrating a mobile DLP system and a security mode data flow thereof according to an embodiment of the present invention.

FIG. 2 is a block diagram illustrating a contents analysis subsystem according to an embodiment of the present invention.

FIG. 3 is a flowchart for describing a file copy function performed by a management program or the contents analysis subsystem according to an embodiment of the present invention.

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terms used herein are for the purpose of describing particular embodiments only and are not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

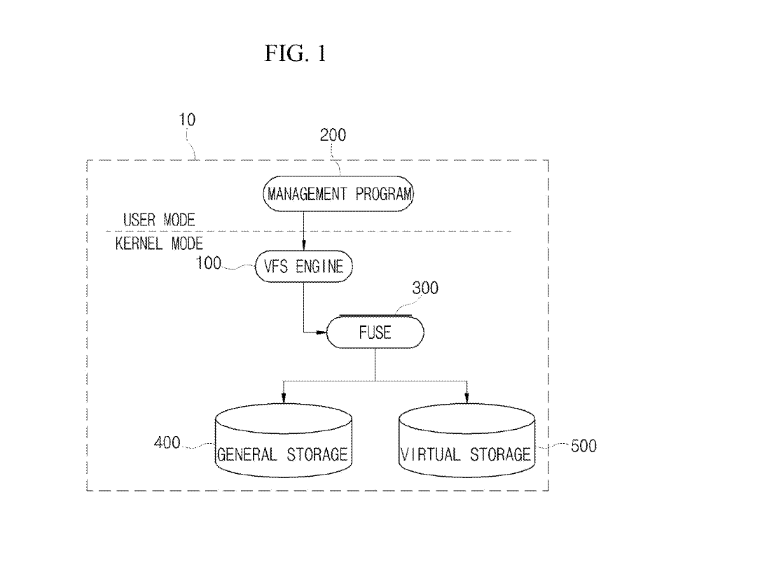

Hereinafter, embodiments of the present invention will be described in detail with reference to the accompanying drawings. FIG. 1 is a block diagram illustrating a mobile DLP system and a security mode data flow thereof according to an embodiment of the present invention.

Referring to FIG. 1, a mobile DLP system 10 according to an embodiment of the present invention includes a general storage 400, a virtual storage 500, a fuse 300, a VFS engine 100, and a management program 200. Here, the mobile DLP system 10 may be included in portable information terminals such as smartphones, smartpads, etc.

The general storage 400 is one storage area of a memory, and enables data to be written/read in a normal mode and a security mode. Storing unapproved personal information and confidential information in the general storage 400 is restricted. Here, the personal information may include a resident registration number, a card number, an account number, etc., and the confidential information is designated important information that needs a security in a company. In this case, the general storage 400 may undergo approval of an officer when editing is performed in the security mode.

The virtual storage 500 is the other storage area of the memory which differs from the general storage 400. The virtual storage 500 enables data to be written/read in the security mode, and it is impossible to access the virtual storage 500 in the normal mode.

The management program 200 designates a file input/output path of a web application (an application program), which is executed in the normal mode without accessing a company network, as the general storage 400, and restricts an access to the virtual storage 500.

When a user accesses the company network to obtain authentication, the normal mode is switched to the security mode, and the management program 200 primarily designates the file input/output path of the executed application as the virtual storage 500. At this time, the management program 200 performs control in the security mode such that a file stored in the virtual storage 500 is edited only in the virtual storage 500, and when moving or copying a file to the general storage 400, the management program 200 may obtain approval of an officer to move or copy the file.

The fuse 300 actually intercepts a file processing of a virtual file system to enable the file processing to be performed based on the virtual storage 500 according to a command of the management program 200, and includes bindFS, UnionFS, and CryptoFS.

The fuse 300 intercepts a file input/output (I/O) of an application including the management program 200 by using the bindFS and UnionFS to change a data storage path, and allows a file to be inputted/outputted based on the virtual storage 500 in the security mode.

When inputting/outputting a file to/from the virtual storage 500, the fuse 300 encrypts the file based on a predetermined key, and inputs the encrypted file to the virtual storage 500. The fuse 300 decrypts the file, and outputs the decrypted file from the virtual storage 500.

Here, the fuse 300 has a bridge function for file system access control of a kernel layer. The fuse 300 is installed based on Linux kernel 2.6.15, and may be used in an operating system (OS) such as a media access control (MAC) OS, Windows, Solaris, or the like.

When the application including the management program 200 commands the VFS engine to process a file, the VFS engine 100 accesses a file system to process the file based on the general storage 400.

The VFS engine 100 performs a bridge function in communication between the fuse 300 of the kernel layer and the application including the management program 200 which operates in an application layer in the security mode. That is, since a kernel environment of an OS is driven by a virtual machine in the security mode, the application including the management program 200 cannot directly access the kernel environment in which an authority is restricted, and thus, the VFS engine 100 that is a bridge connecting the application layer and the kernel layer.

To summarize, the present invention virtualizes a file system (for example, ext3, ext4, yaff2, etc.) installed in a smart terminal platform (for example, android), and allows a user application to use the disk area which is virtualized separately from the physical disk area, thus preventing information from being leaked.

Hereinabove, a case in which the management program 200 primarily designates the file input/output path of the application, executed in the security mode, as only the virtual storage 500 has been described as an example.

However, the management program 200 may allow a file stored in the virtual storage 500 to be primarily edited in only the virtual storage 500, and allow files stored in the general storage 400 to be primarily edited in only the general storage 400. In this case, when a file stored in the general storage 400 is edited in the security mode, the management program 200 may determine whether the file includes personal information and confidential information, and when the file includes personal information and confidential information, the management program 200 may perform control to move the file to the virtual storage 500.

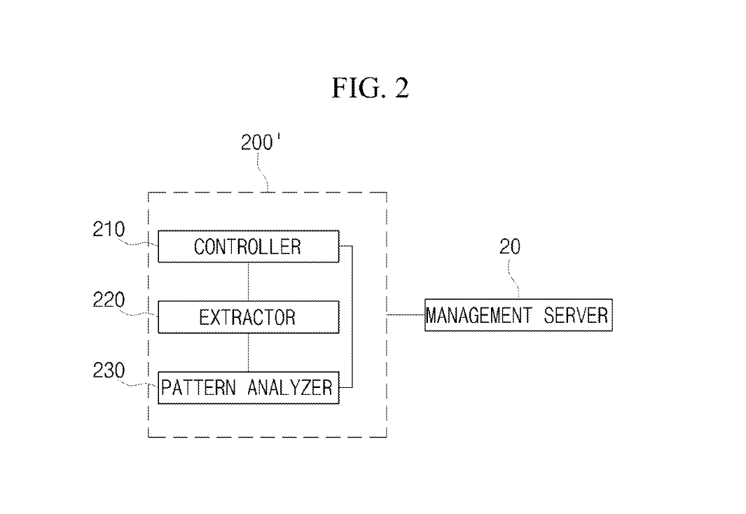

Hereinafter, a contents analysis subsystem (CAS) according to an embodiment of the present invention will be described in detail with reference to FIG. 2. FIG. 2 is a block diagram illustrating a contents analysis subsystem according to an embodiment of the present invention. A CAS 200′ of FIG. 2 may be included in the management program 200 of FIG. 1.

As illustrated in FIG. 2, the CAS 200′ includes a controller 210, an extractor 220, and a pattern analyzer 230. Here, at least one of the controller 210, the extractor 220, and the pattern analyzer 230 may be divided into two elements, and some elements may be implemented as one body.

In the security mode, when a copy target file to be copied from the virtual storage 500 to the general storage 400 by an application is selected according to a user's manipulation, the controller 210 performs user authentication based on a first authentication key. In this case, the controller 210 may request an input of an authentication key from the user, the controller 210 may compare the authentication key inputted by the user and the predetermined first authentication key to authenticate the user.

When the user authentication succeeds, the controller 210 analyzes the copy target file by using the extractor 220 and the pattern analyzer 230, and transmit the analyzed contents and a second authentication key to request approval of copy work from a management server 20. At this time, the controller 210 may additionally transmit information on the copy target file in addition to the analyzed contents and the second authentication key.

When the copy work is approved by the management server 20, the controller 210 copies the copy target file from the virtual storage 500 to the general storage 400.

In the security mode, the extractor 220 analyzes whether the copy target file includes at least one of personal information and confidential information, and extracts a first text corresponding to the at least one piece of information. Here, the personal information may include a resident registration number, a card number, an account number, etc., and the copy target file may be a document file such as “*.doc”, “*.xls”, “*.ppt”, or the like.

The extractor 220 extracts a text corresponding to at least one of the personal information and the confidential information from the copy target file (a binary file) by using Java-based Apach poor obfuscation implementation (POI) library. Here, the Apach POI library is a library used in extracting a text of a document in Java programming, and is POI that is provided as an open source in Apach (http://poi.apache.org/). The Apach POI library reads a binary file, removes an image or a table from the binary file, and extracts only a pure text.

The pattern analyzer 230 analyzes whether at least one of the extracted personal information and confidential information includes a predefined pattern. At this time, the pattern analyzer 230 compares character strings to perform a pattern matching processing by using a Regex function (a character string comparison function) provided from Java. Here, the pattern analyzer 230 may use a library provided from Java.

The pattern analyzer 230 analyzes a type of the extracted personal information and confidential information by using the pattern matching result.

In this way, the CAS 200′ may extract an information text corresponding to at least one of personal information and confidential information from a copy target binary file, compare character strings to perform pattern matching, and request approval from the management server 20. When the approval is obtained, the CAS 200′ may copy a copy target file.

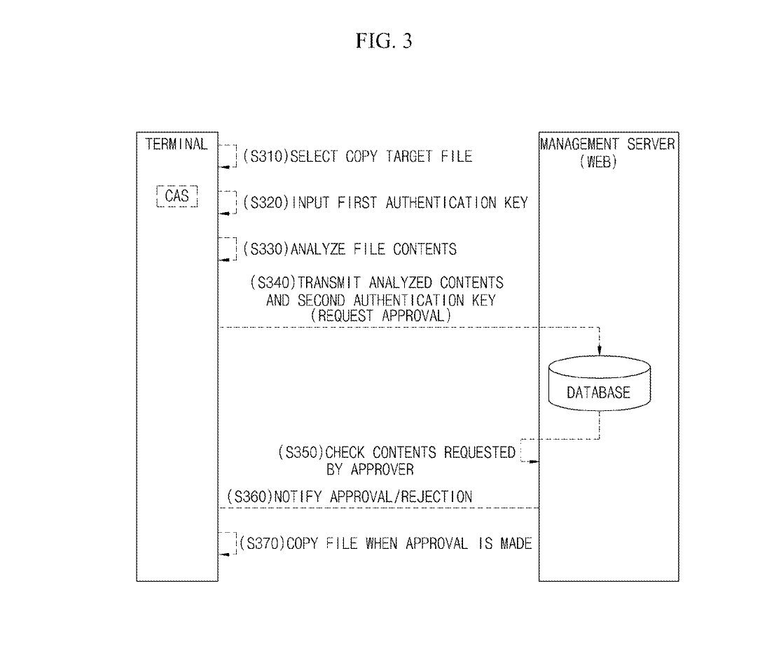

Hereinafter, an operation of performing a file copy function according to an embodiment of the present invention will be described in detail with reference to FIG. 3. FIG. 3 is a flowchart for describing the file copy function performed by the management program or the CAS according to an embodiment of the present invention.

Referring to FIG. 3, when a user selects a copy target file in operation S310, the management program 200 requests user authentication from the user.

When the user inputs an authentication key, the management program 200 determines whether the authentication key is a predetermined first authentication key. When the authentication key matches the predetermined first authentication key, the management program 200 authenticates the user in operation S320.

When the user authentication is completed, the management program 200 analyzes contents of the copy target file in operation S330. At this time, the management program 200 determines whether the contents of the copy target file include at least one of personal information and confidential information, analyzes a pattern of at least one of the personal information and confidential information, and checks a type of at least one of the personal information and confidential information.

The management program 200 transmits the analyzed contents and an approval request message including a second authentication key to the management server 20 by using HTTP protocol to request approval of copy work in operation S340. Here, the analyzed contents may be relevant to whether the copy target file includes at least one of the personal information and confidential information and may include a type of at least one of the personal information and confidential information, and the second authentication key may be the same first authentication key.

The management server 20 stores an approval request message in a database, requests approval from a predetermined officer, and checks whether there is approval in operation S350. In this case, by displaying a text or a screen, the management program 200 requests approval from an approver or a personal information protection officer.

The management server 20 transfers an approval/rejection notification, indicating whether the copy work is approved, to a terminal in operation S360. That is, when the copy work is approved by an officer, the management server 20 notifies approval, and when the copy work is rejected by an officer, the management server 20 notifies rejection. Here, the terminal includes the DLP system 10 of FIG. 1.

When the management program 200 confirms approval of the copy work with the approval/rejection notification, the management program 200 copies a file in operation S370. However, when the management program 200 confirms rejection of the copy work with the approval/rejection notification, the management program 200 informs the user of the rejection of the copy work.

As described above, the present invention strictly classifies and restricts users desiring to access a company network through user authentication, allows work using a smartphone to be performed in a virtual security environment, determines whether a file stored in the virtual security environment includes personal information and confidential information when the file is required to be copied from the virtual security environment to a general environment, analyzes and extracts data corresponding to the personal information and confidential information according to a predefined process to store a corresponding record, and obtains approval of the record from an approver or a company personal information protection officer, thus preventing the personal information or confidential information from being leaked maliciously.

Moreover, despite that a user terminal is controlled by an unauthorized user due to file copy, loss of the user terminal, or the unauthorized user obtaining a user account, when desiring to copy a file (including personal information and confidential information stored in a file system virtualization area) to a physical disk of a general storage for taking out the file, approved is requested, and thus, an officer recognizes an approval request of an unauthorized user. Accordingly, the present invention ensures stable copy work performed by an authorized user, and fundamentally prevents the file from being leaked by the unauthorized user.

According to the present invention, when desiring to copy a file, including at least one of personal information and confidential information stored in a file system virtualization area, to a general storage for taking out the file, approval is obtained, and thus, stable copy work performed by an authorized user can be ensured, and a file can be fundamentally prevented from being leaked by an unauthorized user.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A mobile data loss prevention (DLP) system comprising:
a general storage configured to allow an access in a normal mode and a security mode;
an encrypted virtual storage configured to disallow an access in the normal mode, and allow an access in the security mode;
a management program configured to designate the general storage as a write or read area in the normal mode, and designate the general storage and the virtual storage as the write or read area in the security mode;
a fuse configured to intercept a file input or output of an application program comprising the management program to again set a file input or output path as the virtual storage according to a command of the management program, in the security mode; and
a VFS engine configured to perform a bridge function between the application program of an application layer and the fuse of a kernel layer.

2. The mobile DLP system of claim 1, wherein the management program comprises:
an extractor configured to, when there is a file to be copied from the virtual storage from the general storage in the security mode, determine whether the copy target file comprises at least one of personal information and confidential information, and when the copy target file comprises the at least one piece of information, extract the at least one piece of information;
a pattern analyzer configured to compare the extracted at least one piece of information and a predefined pattern to analyze a type of the at least one piece of information; and
a controller configured to request approval of copy work for the copy target file from an officer by using an authentication key and the analyzed contents that comprise the type of the at least one piece of information and information on whether the copy target file comprises the at least one piece of information.

3. The mobile DLP system of claim 2, wherein the extractor extracts a text corresponding to the at least one piece of information by using Java-based Apach POI library.

4. The mobile DLP system of claim 2, wherein the pattern analyzer determines the type of the at least one piece of information by performing a pattern matching processing that compares the at least one piece of information and the predefined pattern by using a Java-based character string comparison function.

5. A file copy method of a mobile data loss prevention (DLP) system, including a general storage configured to allow an access in a normal mode and a security mode and an encrypted virtual storage configured to disallow an access in the normal mode and allow an access in the security mode, the file copy method comprising:
when copy work is requested for copy from the virtual storage to the general storage, requesting, by an application program comprising a management program, authentication from a user requesting the copy work in the security mode;
when the user is authenticated, analyzing a copy target file corresponding to the copy work, and transmitting the analyzed contents to request approval of the copy work; and
when a notification indicating approval of an officer for the copy work is received from a server, copying the copy target file of the virtual storage to the general storage.

6. The file copy method of claim 5, wherein the analyzing of a copy target file and the requesting of approval comprise:
determining whether the copy target file comprises at least one of personal information and confidential information;
when the copy target file comprises the at least one piece of information, extracting the at least one piece of information;
comparing at least one piece of information and a predefined pattern to check a type of the at least one piece of information; and
transmitting an authentication key and the analyzed contents, which comprise at least one of: the type of the at least one piece of information; and information on whether the copy target file comprises the at least one piece of information, to request the approval.

7. The file copy method of claim 5, wherein the requesting of authentication comprises:
requesting an input of an authentication key from the user;
comparing the authentication key inputted by the user and a predetermined authentication key; and
when the input authentication key matches the predetermined authentication key, authenticating the user.

8. The file copy method of claim 5, further comprising, when a notification indicating rejection of the officer for the copy work is received from the server, informing the user of the rejection of the copy work.
